(19) United States
(12) Patent Application Publication
(10) Pub. No.: US 2009/0007838 A1
(43) Pub. Date: Jan. 8, 2009

(54) Flag Display Assembly

(76) Inventor: Bill Robinson, Greensboro, NC (US)

Correspondence Address: Jay M. Schloff;Intellipex PLLC, Suite 245, 30200 Telegraph Road, Bingham Farms, MI, 48025, US

(21) Appl. No.: 11/772,349

(22) Filed: Jul. 2, 2007

(51) Int. Cl. G09F 17/00

(52) U.S. Cl. 116/173

(57) ABSTRACT

Disclosed is a flag display assembly capable of being secured to a trailer hitch receiver of a vehicle for the purpose of displaying flags. The flag display assembly comprises a center plate; a cross bar coupled to the center plate; a first flag staff engaging member and a second flag staff engaging member coupled to opposite end portions of the cross bar; a first flag staff removably engaged to the first flag staff engaging member; a second flag staff removably engaged to the second flag staff engaging member; and an engaging unit coupled to the center plate. The engaging unit capable of being received within the trailer hitch receiver of the vehicle, and secured therein, thereby engages the flag display assembly to the trailer hitch receiver for displaying a first flag and a second flag.

### FIELD OF THE INVENTION

The present invention relates to flag display arrangements on vehicles, and more particularly, to a flag display assembly capable of being secured to a trailer hitch receiver of a vehicle for the purpose of displaying flags.

### BACKGROUND OF THE INVENTION

Flags of nations have played an important role in the history of mankind. An individual's association with the flag of his nation is a very potent patriotic association. Nowadays, other than showing patriotism, the flags are also used for messaging, advertising and for a plurality of other reasons. Besides the conventional method of displaying flags on stationary flag staff or flagpoles, nowadays flags are also displayed on vehicles. Rarely is any vehicle configured with flag display arrangements at the time of manufacturing. Although vehicles are not equipped to display flags, individuals try to meet their desire for displaying flags by using a variety of basic arrangements. For example, for the purposes of showing their respect and solidarity to their country, organization, team, or other group, individuals usually attach a flag at an upper end of a radio antenna or secure the flag staff at the front or rear of the vehicle with some tying means.

In recent times, many efforts have been made to dispose and display the flags with the trailer hitch receiver that is present in most sport utility vehicles, vans, and pick-up trucks. However, when such vehicles are in motion, a significant rush of air is exerted on a flag staff holding the flag in existing devices, making the same vulnerable to be broken or detached from the vehicle.

Several attempts have been made in the past to provide a flag support system that is attached to a vehicle's trailer hitch. For example, US Patent Application Publication No. 20060156600 discloses an apparatus and method for mounting poles to vehicles, permitting the mounting of one or more flagpoles to a receiver of a trailer hitch assembly of a vehicle. The flagpole passing through the support tube is part of the apparatus such that the flagpole rests upon and is supported in part by the ground. This prior art has a disadvantage of not allowing a user to move the vehicle while using the disclosed apparatus to support and display a flag for the reason that the disclosed apparatus requires the flag to be supported by the ground.

US Patent Application Publication No. 20060053667 discloses a vehicle flag holder for mounting to a hitch receiver of a vehicle having a flagpole receiver comprising a tongue mount portion and a pole-receiving portion. The tongue mount portion is received by the vehicle hitch receiver and pole-receiving portion is attached to the tongue mount portion. The pole-receiving portion includes a vertical section having aligned pivot pin receiving bores, upright positioning pores, and a horizontally-mounted locking pin receiving flange having a locking pin bore there through. This prior art allows a user to mount a plurality of flags on the rear of a vehicle; however, flag pole receiving aspect of the disclosed prior art is configurationally complicated.

US Patent Application Publication No. 20040041070 discloses an apparatus for mounting a flag to a receiver assembly on a vehicle. The apparatus includes a pole for receiving and carrying a flag. The apparatus also includes a body having a bar for securing the body to the receiver assembly, a mount for receiving and holding the pole and a fastener for securing the pole to the mount. This prior art mates with a separate device that is installed on a vehicle's trailer hitch and is not contemplated for use with a vehicle featuring only a trailer hitch.

U.S. Pat. No. 6,808,098 discloses a flag mast holder assembly that can accommodate trailer hitch ball mounts. The mast holder assembly includes a central bore for receiving the mast of a flag or pennant and is preferably made of aluminum. The mast holder is provided with stainless steel flat washers, lock washer, and a securing nut. This prior art discloses displaying of only one flag at a time.

U.S. Pat. No. 6,582,314 discloses a device attached to the exterior of a motor vehicle, with an upwardly extending arm producing a passive lateral oscillation due to vehicle motion to simulate a wagging animal tail. The disclosed device includes a base plate, which attaches to the vehicle between a license plate mounting area and the license plate. A laterally flexible arm is attached to the distal end of the bracket. This prior art discloses an upwardly-extending pole or shaft from the rear of a vehicle, however, the disclosed device does not contemplate mounting with a trailer hitch of a vehicle.

U.S. Pat. No. 6,557,483 discloses a detachable vehicle trailer hitch display flag apparatus, the trailer hitch of the type having a removable towing ball. The disclosed apparatus comprises an elongated, preferably tubular, flag staff having a display flag attached or releasably attachable to an upper end portion thereof and an elongated straight support shaft adapted at a lower end thereof to be releasably attachable to the trailer hitch in upwardly extending and upright orientation in place of the towing ball when it is removed. A lower end of the flag staff is slidably engageable over the support shaft in coaxial upwardly extending alignment with the support shaft. A releasable locking arrangement holds the flag staff and the support shaft together while the apparatus is in use. This prior art contemplates displaying only one flag, with the display being in such proximity to the vehicle that there may be insufficient air current to cause the flag to fully unfurl and flutter.

Accordingly, what is needed is a flag display assembly having reduced configurational complexities and capable of being secured easily and firmly into a trailer hitch receiver of a vehicle for displaying more than one flag and for ensuring that the displayed flags will unfurl fully.

### SUMMARY OF THE INVENTION

In view of the foregoing disadvantages inherent in the prior art, the general purpose of the present invention is to provide a flag display assembly to include all the advantages of the prior art, and to overcome the drawbacks inherent therein.

In one aspect, the present invention provides a flag display assembly. The flag display assembly comprises a center plate, a cross bar, a first flag staff engaging member, a second flag staff engaging member, a first flag staff, a second flag staff and an engaging unit. The center plate has a front face and a rear face. The cross bar comprises a first end portion, a second end portion, and a middle portion. The middle portion of the cross bar is coupled to the rear face of the center plate. The first flag staff engaging member is coupled to the first end portion of the cross bar. The second flag staff engaging member is coupled to the second end portion of the cross bar. The engaging unit is coupled to the rear face of the center plate. The first flag staff comprises a first top portion capable of mounting a first flag for display and a first bottom portion capable of removably engaging with the first flag staff engaging member. The second flag staff comprises a second top portion capable of mounting a second flag for display and a second bottom portion capable of removably engaging with the second flag staff engaging member. The engaging unit is capable of being received within a trailer hitch receiver of a vehicle, and secured therein, and thereby engages the flag display assembly to the trailer hitch receiver for displaying the first flag and second flag.

This together with other aspects of the present invention, along with the various features of novelty that characterize the invention, are pointed out with particularity in the claims annexed hereto and forms a part of this invention. For a better understanding of the invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is a perspective view of a flag display assembly 200 capable of being secured to a trailer hitch receiver 170 of a vehicle for displaying a first flag 190 and a second flag 192, according to an exemplary embodiment of the present invention;

FIG. 2 is a exploded perspective view of the flag display assembly 200, according to an exemplary embodiment of the present invention;

FIG. 3 is a front view of the flag display assembly 200, according to an exemplary embodiment of the present invention;

FIG. 4 is a side view of the flag display assembly 200, according to an exemplary embodiment of the present invention; and

FIG. 5 is a perspective view of flag display assembly 200 in a utilized condition, when the flag display assembly 200 is secured within trailer hitch receiver 170, according to an exemplary embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular flag display assembly, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides an easy-to-use flag display assembly having substantially reduced configurational complexities for the purpose of displaying flags. The flag display assembly of the present invention is capable of being removably engaged to a trailer hitch receiver of a vehicle for displaying flags. With such an engagement, the flags may be securely displayed at the rear of a vehicle, whereby the flags can be prominently displayed, while at the same time the undesirable flapping of the flags due to strong winds can be avoided. Furthermore, flag wires that are inserted into the displayed flags ensure that the flags will fully display regardless of wind conditions.

The flag display assembly of the present invention may be mass manufactured in a cost effective manner based on the dimensions of the various standard trailer hitch receivers, for example 2 inch and 1¼ inch-sized receivers, to be used for securing the flag display assembly. The wire-formed construction of one embodiment of the invention allows the invention to be built at a low cost and at a light weight that aids in a user's installation and manipulation of the assembly.

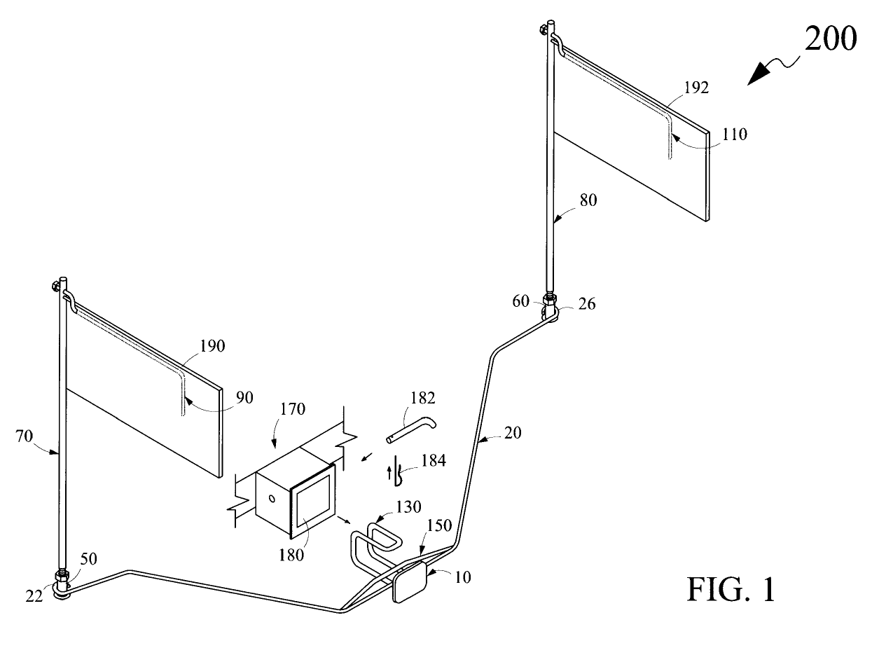

Referring to FIGS. 1-5, a flag display assembly 200 is shown. The flag display assembly 200 comprises a center plate 10; a cross bar 20 coupled to the center plate 10; a first flag staff engaging member 50 and a second flag staff engaging member 60 coupled to opposite end portions of the cross bar 20; a first flag staff 70 removably engaged to the first flag staff engaging member 50; a second flag staff 80 removably engaged to the second flag staff engaging member 60; and an engaging unit 130 coupled to the center plate 10. The engaging unit 130 is capable of being received within a trailer hitch receiver 170 of a vehicle (not shown), and secured therein, thereby engaging the flag display assembly 200 to the trailer hitch receiver 170 for displaying a first flag 190 and a second flag 192. The material used for manufacturing the flag display assembly 200 includes, but is not limited to, steel, aluminum, and the like.

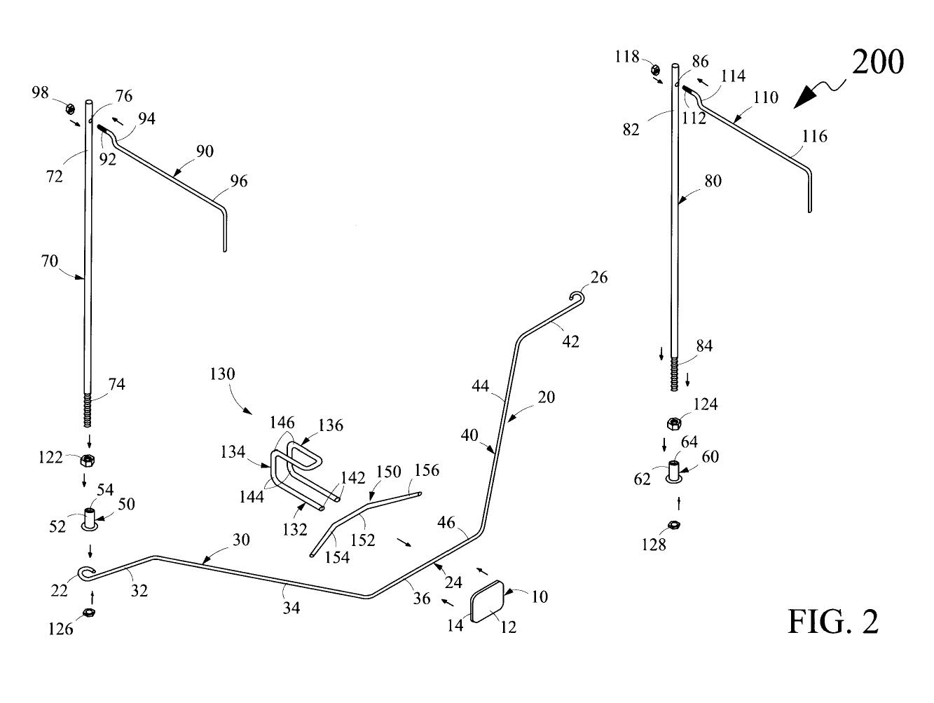

Referring to FIG. 2, the flag display assembly 200, is shown in an exploded perspective view. The center plate 10 of the flag display assembly 200 is a rectangular shaped structure having a front face 12 and a rear face 14. The rear face 14 is coupled to the cross bar 20 and the engaging unit 130 in a manner such that the cross bar 20 lies above the engaging unit 130. In one embodiment of the present invention, the rear face 14 of the center plate 10 is welded to the cross bar 20 and the engaging unit 130.

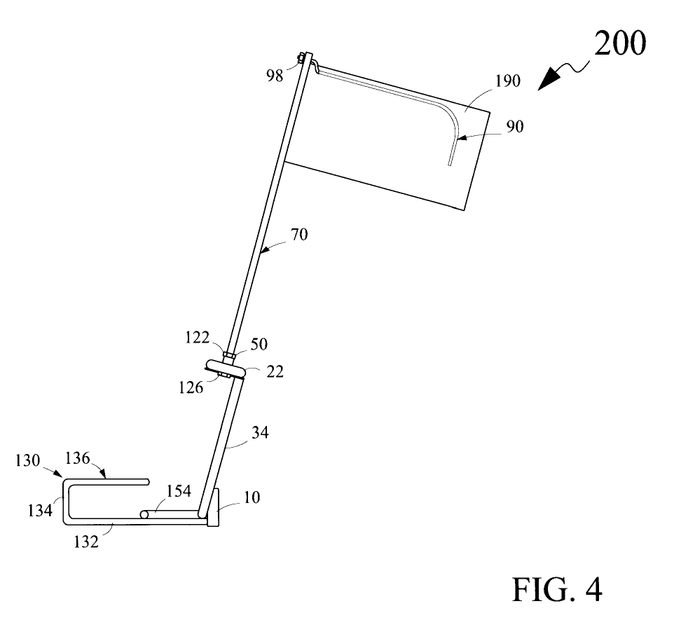

The cross bar 20 is a cylindrical elongated structure having a first end portion 22, a middle portion 24 and a second end portion 26. The middle portion 24 of the cross bar 20 is coupled to the rear face 14 of the center plate 10. In one embodiment of the present invention, when the cross bar 20 is coupled to the rear face 14 of the center plate 10, a longitudinal plane of the cross bar 20 configures an angle of 75 degrees to a plane perpendicular to the center plate 10. In such a configuration, the first flag staff 70 and the second flag staff 80 are inclined at an angle of 75 degrees to the plane perpendicular to the center plate 10, (See FIG. 4). The coupling of the longitudinal plane of the cross bar 20 at the angle of 75 degrees gives an aesthetic look to the flag display assembly 200 upon receiving into the trailer hitch receiver 170 when the first flag staff 70 and the second flag staff 80 are mounted with the first flag 190 and the second flag 192, respectively.

The first end portion 22 and the second end portion 26 of the cross bar 20 have bend structures. More specifically, in one embodiment, the bend structures of the first end portion 22 and the second end portion 26 are circular in shape and capable of receiving and coupling with the first flag staff engaging member 50 and the second flag staff engaging member 60, respectively. The first end portion 22 and the second end portion 26 are spaced apart from the middle portion 24 by a first intermediate portion 30 and a second intermediate portion 40, respectively.

The first intermediate portion 30 extends from the first end portion 22 to the middle portion 24. The first intermediate portion 30 comprises a first horizontal link 32, a second horizontal link 36 and an inclined link 34, such that the inclined link 34 extends from the first horizontal link 32 to the second horizontal link 36. The first horizontal link 32 is connected to the first end portion 22 and the second horizontal link 36 is connected to the middle portion 24.

Further, the second intermediate portion 40 extends from the middle portion 24 to the second end portion 26. The second intermediate portion 40 comprises a first horizontal link 42, a second horizontal link 46 and an inclined link 44, such that the inclined link 44 extends from the first horizontal link 42 to the second horizontal link 46. The first horizontal link 42 is connected to the second end portion 26 and the second horizontal link 46 is connected to the middle portion 24.

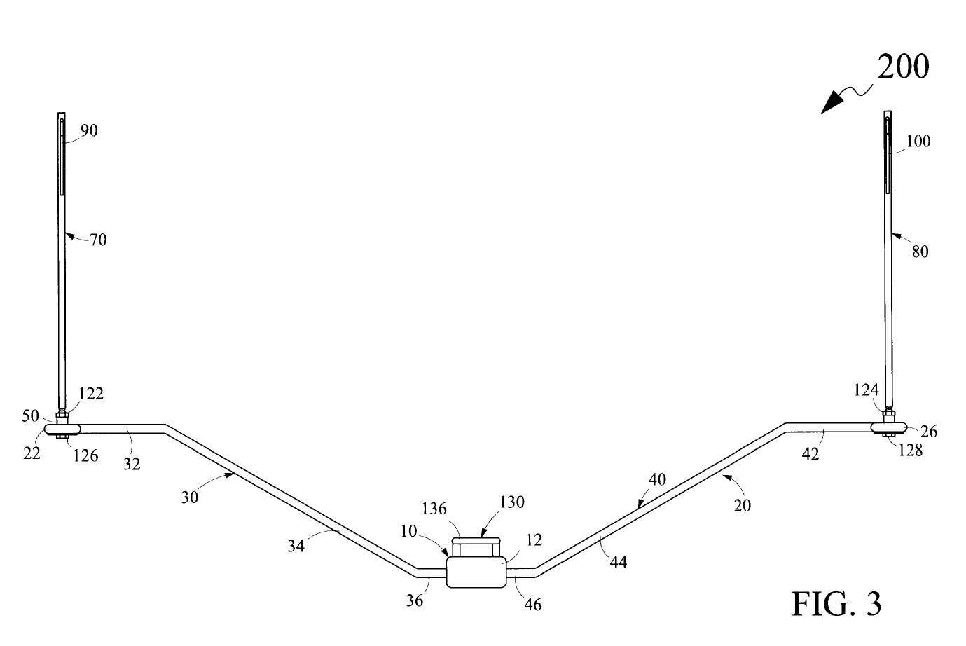

The first intermediate portion 30 and the second intermediate portion 40 are configured to hold the first flag staff 70 coupled to the first end portion 22 and the second flag staff 80 coupled to the second end portion 26, at a height away from ground level that is greater than the trailer hitch receiver's 170 height from ground level when the flag display assembly 200 is engaged to the trailer hitch receiver 170. More specifically, as shown in FIG. 3 the first horizontal link 32 and the inclined link 34 of the first intermediate portion 30 configure an angle of 150 degrees between the first horizontal link 32 and the inclined link 34. Further, the second horizontal link 36 and the inclined link 34 of the first intermediate portion 30 configure an angle of 150 degrees between the second horizontal link 36 and inclined link 34.

Similarly, the first horizontal link 42 and the inclined link 44 of the second intermediate portion 40 configure an angle of 150 degrees between the first horizontal link 42 and the inclined link 44. Further, the second horizontal link 46 and the inclined link 44 of the second intermediate portion 40 configure an angle of 150 degrees between the second horizontal link 46 and inclined link 44. Such configuration of the first horizontal links 32, 42, the inclined links 34, 44 and the second horizontal links 36, 46 in the cross bar 20 enables in holding the first horizontal link 32 coupled to the first end portion 22 and the first horizontal link 42 coupled to second end portion 26 in an upright position when the middle portion 24 of the cross bar 20 is coupled to the center plate 10. Accordingly, such a configuration of the cross bar 20 enables in holding the first flag staff 70 and the second flag staff 80 at the greater height away from the ground level.

The first flag staff engaging member 50 and the second flag staff engaging member 60 are hollow cylindrical structures. The first flag staff engaging member 50 has an outer surface 52 and an inner surface 54 and the second flag staff engaging member 60 has an outer surface 62 and an inner surface 64. The outer surface 52 of the first flag staff engaging member 50 is coupled to the bend structure of the first end portion 22 and the outer surface 62 of the second flag staff engaging member 60 is coupled to the bend structure of the second end portion 26.

In one embodiment of the present invention, the outer surface 52 of the first flag staff engaging member 50 and the outer surface 62 of the second flag staff engaging member 60 are welded to the first end portion 22 and to the second end portion 26 of the cross bar 20, respectively. The inner surface 54 of the first flag staff engaging member 50 and the inner surface 64 of the second flag staff engaging member 60 have engagement features capable of removably engaging the first flag staff 70 and the second flag staff 80, respectively. In one embodiment, the first flag staff engaging member 50 and the second flag staff engaging member 60 are hub washers having internal threads.

The first flag staff 70 and the second flag staff 80 are cylindrical elongated structures. The first flag staff 70 comprises a first top portion 72 capable of mounting the first flag 190, and a first bottom portion 74 capable of removably engaging with the inner surface 54 of the first flag staff engaging member 50. More particularly, the first bottom portion 74 of the first flag staff 70 has engagement features disposed on an outside surface of the first flag staff 70 and capable of removably engaging with the complementary engagement features disposed on the inner surface 54 of the first flag staff engaging member 50.

The second flag staff 80 comprises a second top portion 82 capable of mounting the second flag 192 and a second bottom portion 84 capable of removably engaging with the inner surface 64 of the second flag staff engaging member 60. More particularly, the second bottom portion 84 of the second flag staff 80 has engagement features disposed on an outside surface of the second flag staff 80 and capable of removably engaging with the complementary engagement features disposed on the inner surface 64 of the second flag staff engaging member 60. In one embodiment, the first bottom portion 74 and the second bottom portion 84 of the first flag staff 70 and the second flag staff 80, have external threads.

The first flag staff 70 further comprises a first hole 76 disposed about the first top portion 72 of the first flag staff 70 and capable of receiving a first flag wire 90 such that the first flag wire 90 extends outwardly and laterally from the first top portion 72. The first flag wire 90 comprises a first threaded portion 92 extending from a first end to a second end, a first bend portion 94 extending from the second end to a third end and a first L-shaped portion 96 extending from the third end. More particularly, the first bend portion 94 extends downwardly perpendicular to the first threaded portion 92 and the first L-shaped portion 96 extends outwardly perpendicular to the first bend portion 94. Further, the first threaded portion 92, the first bend portion 94 and the first L-shaped portion 96 of the first flag wire 90 are in same plane.

Upon mounting the first flag 190 on the first top portion 72 of the first flag staff 70, the first L-shaped portion 96 of the first flag wire 90 is received within the first flag 190 through a hole disposed about an edge of the first flag 190. The first bend portion 94 of the first flag wire 90 enables in restricting the first L-shaped portion 96 to completely pass through the first hole 76 upon receiving the first threaded portion 92 of the first flag wire 90. Further, a lock nut 98 is engaged to the first threaded portion 92 extending out of the first hole 76 and thereby holds the first flag wire 90 along with the first flag 190 to the first flag staff 70. Such a configuration of the first flag wire 90 and the first flag 190 enables in holding the first flag 190 in full display condition in any wind load with the support of the first flag wire 90.

The second flag staff 80 further comprises a second hole 86 disposed about the second top portion 82 of the second flag staff 80 and capable of receiving a second flag wire 110 such that, the second flag wire 110 extends outwardly and laterally from the second top portion 82. The second flag wire 110 comprises a second threaded portion 112 extending from a first end to a second end, a second bend portion 114 extending from the second end to a third end and a second L-shaped portion 116 extending from the third end. More particularly, the second bend portion 114 extends downwardly perpendicular to the second threaded portion 112 and the second L-shaped portion 116 extends outwardly perpendicular to the second bend portion 114. Further, the second threaded portion 112, the second bend portion 114 and the second L-shaped portion 116 of the second flag wire 110 are in same plane.

Upon mounting the second flag 192 on the second top portion 82 of the second flag staff 80, the second L-shaped portion 116 of the second flag wire 110 is received within the second flag 192 through a hole disposed about an edge of the second flag 192. The second bend portion 114 of the second flag wire 110 enables in restricting the second L-shaped portion 116 to completely pass through the second hole 86 upon receiving the second threaded portion 112 of the second flag wire 110. Further, a lock nut 118 engaged to the second threaded portion 112 extending out of the second hole 86 and thereby holding the second flag wire 110 along with the second flag 192 to the second flag staff 80. Such a configuration of the second flag wire 110 and the second flag 192 enables in holding the second flag 192 in full display condition in any wind load with the support of the second flag wire 110.

The engaging unit 130 of the flag display assembly 200 comprises a lower portion 132 extending from a first end to a second end, an intermediate portion 134 extending upwardly and perpendicularly from the second end to a third end and an upper portion 136 extending perpendicularly from the third end towards the center plate 10. The lower portion 132 is coupled to the rear face 14 of the center plate 10 at the first end and extends perpendicularly from the rear face 14 of the center plate 10.

In one embodiment of the present invention, the lower portion 132 comprises a pair of first spaced apart elongated structures extending from first ends 142 to second ends 144. The intermediate portion 134 comprises a pair of second spaced apart elongated structures extending upwardly and perpendicularly from the second ends 144 to third ends 146. The upper portion 136 having a U-shaped structure extending perpendicularly from the third ends 146 towards the center plate 10. The pair of first spaced apart elongated structures is coupled to the rear face 14 of the center plate 10 at the first ends 142 such that the pair of first spaced apart elongated structures extends perpendicularly from the rear face 14 of the center plate 10. In one embodiment of the present invention, the pair of first spaced apart elongated structures is welded to the rear face 14 of the center plate 10 at the first end 142.

The engaging unit 130 further comprises a rod 150 coupled laterally to the lower portion 132 of the engaging unit 130 and to the cross bar 20. More specifically, the rod 150 is disposed laterally on the pair of first spaced apart elongated structures between the first ends 142 and the second ends 144. The rod comprises a central portion 152 having a first end and a second end, a first portion 154 coupled to the first end of the central portion 152 and to the cross bar 20, and a second portion 156 coupled to the second end of the central portion 152 and to the cross bar 20.

The central portion 152 of the rod 150 is coupled to the lower portion 132 of the engaging unit 130 and enables in restricting the engaging unit 130 to slide completely into a cavity 180 of the trailer hitch receiver 170, upon receiving the engaging unit 130 into the cavity 180 of the trailer hitch receiver 170. The cavity 180 of the trailer hitch receiver 170 is configured by the walls 172, 174, 176 and 178. Thus, on receiving the engaging unit 130 into the trailer hitch receiver 170, the intermediate portion 136 of the engaging unit 130 is housed inside the cavity 180 with the lower portion 132 contacting the lower wall 176 of the trailer hitch receiver 170 and the upper portion 136 contacting the upper wall 172 of the trailer hitch receiver 170.

The first portion 154 of the rod 150 is connected to the cross bar 20 at a point connecting the inclined link 34 and the second horizontal link 36 of the first intermediate portion 30. Similarly, the second portion 156 of the rod 150 is connected to the cross bar 20 at a point connecting the inclined link 44 and the second horizontal link 46 of the second intermediate portion 40. However, the first portion 154 and the second portion 156 may be coupled to the cross bar 20 at other positions thereon. Further, the first portion 154 and the second portion 156 of the rod 150 enables in strengthening the coupling of the engaging unit 130 and the cross bar 20.

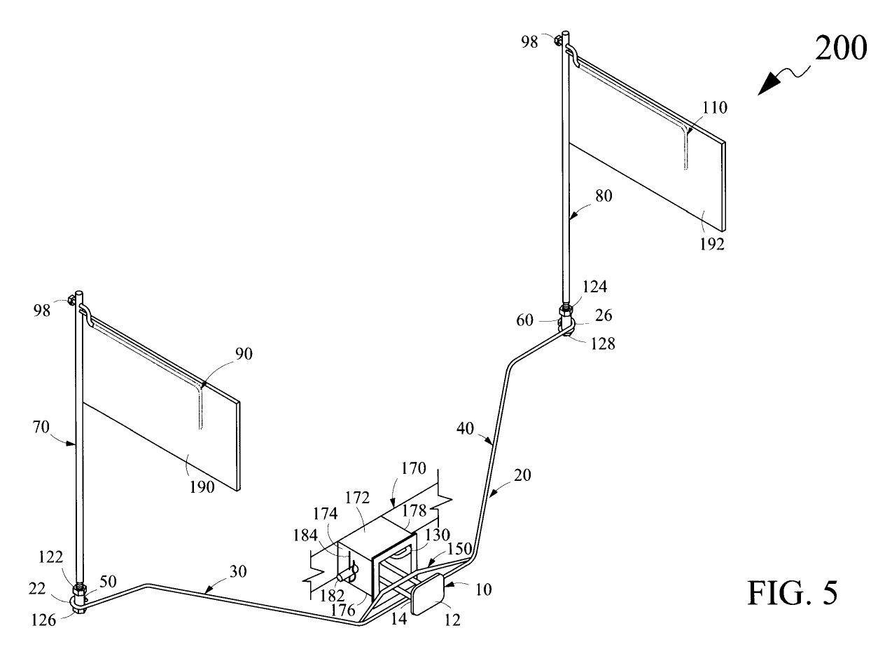

The engaging unit 130 is secured to the trailer hitch 170 receiver using a pull pin 182 and a cotter pin 184. The push pin 182 passes through a pair of aligned holes disposed on the side walls 174, 178 of the cavity 180 of the trailer hitch receiver 170 and through a space between the upper portion 136 and the lower potion 132 of the engaging unit 130. The push pin 182 contacts a front of the intermediate portion 134 of the engaging unit 130, thereby securing the engaging unit 130 stationary relative to the cavity 180 of the trailer hitch receiver 170. Further, the cotter pin 184 passes through a hole disposed on a front end of the push pin 182 and holds the push pin 182 stationary relative to the pair of aligned holes disposed on the side walls 174, 178 when the push pin 182 passes through the aligned holes disposed on the side walls 174, 178 and extends out, (See FIG. 5).

The flag display assembly 200 further comprises a plurality of nuts for firmly engaging the first flag staff 70 and the first flag staff engaging member 50 about the first end portion 22 and for firmly engaging the second flag staff 80 and the second flag staff engaging member 60 about the second end portion 26.

The plurality of nuts used for firmly engaging the first flag staff 70 and the first flag staff engaging member 50 comprise a first nut 122 and a first lock nut 126. The first nut 122 and the first lock nut 126 are capable of removably engaging with the first bottom portion 74 of the first flag staff 70. The length of the first bottom portion 74 is long enough such that the first bottom portion 74 is capable of engaging with the first nut 122, the first lock nut 126 and the first flag staff engaging member 50 about the first end portion 22 of the cross bar 20.

The first nut 122 is engaged to an upper end portion of the first bottom portion 74. Thereafter, the first flag staff 70 along with the first nut 122 is engaged to the first flag staff engaging member 50 about an intermediate portion of the first bottom portion 74, such that, the first flag 190 mounted on the first top portion 72 trails straight back. The first lock nut 126 is engaged to a lower end portion of the first bottom portion 74 extending out of the first flag staff engaging member 50. Thus, the first nut 122 gets disposed on a top of the first flag staff engaging member 50 and the first lock nut 126 gets disposed on a bottom of the first flag staff engaging member 50 upon firmly engaging the first flag staff 70 and the first flag staff engaging member 50 (See FIG. 3).

The plurality of nuts used for firmly engaging the second flag staff 80 and the second flag staff engaging member 60 comprise a first nut 124 and a first lock nut 128. The first nut 124 and the first lock nut 128 are capable of removably engaging with the second bottom portion 84 of the second flag staff 80. The length of the second bottom portion 84 is long enough such that the second bottom portion 84 is capable of engaging with the first nut 124, the first lock nut 128 and the second flag staff engaging member 60 about the second end portion 26 of the cross bar 20.

The first nut 124 is engaged to an upper end portion of the second bottom portion 84. Thereafter, the second flag staff 80 along with the first nut 124 is engaged to the second flag staff engaging member 60 about an intermediate portion of the second bottom portion 84 such that the second flag 192 mounted on the second top portion 82 trails straight back. The first lock nut 128 is engaged to a lower end portion of the second bottom portion 84 extending out of the second flag staff engaging member 60. Thus, with the first nut 124 disposed on a top of the second flag staff engaging member 60 and the first lock nut 128 disposed on a bottom of the second flag staff engaging member 60 upon firmly engaging the second flag staff 80 and the second flag staff engaging member 60, refer to FIG. 3.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, and to thereby enable others skilled in the art to best utilize the invention and various embodiments with various modifications as are suited to the particular use contemplated. It is understood that various omissions and substitutions of equivalents are contemplated as circumstances may suggest or render expedient, but such are intended to cover the application or implementation without departing from the spirit or scope of the claims of the present invention.

What is claimed is:

1. A flag display assembly, comprising:
a center plate having a front face and a rear face;
a cross bar comprising a first end portion, a second end portion, and a middle portion, the middle portion coupled to the rear face of the center plate;
a first flag staff engaging member coupled to the first end portion of the cross bar;
a second flag staff engaging member coupled to the second end portion of the cross bar;
a first flag staff comprising
a first top portion capable of mounting a first flag for display, and
a first bottom portion capable of removably engaging with the first flag staff engaging member;
a second flag staff comprising
a second top portion capable of mounting a second flag for display, and
a second bottom portion capable of removably engaging with the second flag staff engaging member; and
an engaging unit coupled to the rear face of the center plate, the engaging unit capable of being received within a trailer hitch receiver of a vehicle, and secured therein, thereby engaging the flag display assembly to the trailer hitch receiver for displaying the first flag and second flag.

2. A flag display assembly of claim 1, wherein the engaging unit comprises
a lower portion extending from a first end to a second end, the lower portion coupled to the rear face of the center plate at the first end, and the lower portion extending perpendicularly from the rear face of the center plate,
an intermediate portion extending upwardly and perpendicularly from the second end to a third end, and
an upper portion extending perpendicularly from the third end towards the center plate.

3. A flag display assembly of claim 1, wherein the engaging unit comprises
a lower portion having a pair of first spaced apart elongated structures extending from first ends to second ends, the pair of first spaced apart elongated structures coupled to the rear face of the center plate at the first ends, and the pair of first spaced apart elongated structures extending perpendicularly from the rear face of the center plate,
an intermediate portion having a pair of second spaced apart elongated structures extending upwardly and perpendicularly from the second ends to third ends, and
an upper portion having a U-shaped structure extending perpendicularly from the third ends towards the center plate.

4. The flag display assembly of claim 3, wherein the engaging unit further comprises a rod, the rod comprising
a central portion having a first end and a second end, the central portion laterally coupled to the lower portion of the engaging unit,
a first portion coupled to the first end of the central portion and to the cross bar, and
a second portion coupled to the second end of the central portion and to the cross bar,
wherein the central portion enables in restricting the engaging unit to slide completely into a cavity of the trailer hitch receiver, and
wherein the first portion and the second portion enables in strengthening the coupling of the engaging unit and the cross bar.

5. The flag display assembly of claim 3, wherein the engaging unit is secured to the trailer hitch receiver using a push pin and a cotter pin,
the push pin passing through a pair of aligned holes disposed on side walls of the trailer hitch receiver and through a space between the upper portion and the lower potion of the engaging unit and contacting a front of the intermediate portion thereby securing the engaging unit in a stationary position relative to the trailer hitch receiver, and
the cotter pin passing through a hole disposed on a front end of the push pin and holding the push pin stationary relative to the pair of holes disposed on the side walls upon passing through the holes disposed on the side walls.

6. The flag display assembly of claim 1, wherein the first end portion and the second end portion of the cross bar are bent structures capable of receiving and coupling with outer surfaces of the first flag staff engaging member and the second flag staff engaging member, respectively.

7. The flag display assembly of claim 1, wherein the first bottom portion and the second bottom portion of the first flag staff and the second flag staff have engagement features disposed on an outside surface capable of removably engaging with complementary engagement features disposed on an inner surface of the first flag staff engaging member and the second flag staff engaging member, respectively.

8. The flag display assembly of claim 1, wherein the cross bar further comprises
a first intermediate portion extending from the first end portion to the middle portion of the cross bar, the first intermediate portion having
a first horizontal link,
a second horizontal link, and
an inclined link connecting the first horizontal link and the second horizontal link, the first horizontal link is connected to the first end portion and the second horizontal link is connected to the middle portion, and
a second intermediate portion extending from the middle portion to the second end portion of the cross bar, the second intermediate portion having
a first horizontal link,
a second horizontal link, and
an inclined link connecting the first horizontal link and the second horizontal link, the first horizontal link is connected to the second end portion and the second horizontal link is connected to the middle portion,
wherein the first intermediate portion and the second intermediate portion are configured in a manner to hold the first flag staff coupled to the first end portion and the second flag staff coupled to the second end portion at a greater height away from a ground level when the flag display assembly is engaged to the trailer hitch receiver.

9. The flag display assembly of claim 1, wherein the cross bar is coupled to the rear face of the center plate in a manner such that a longitudinal plane of the cross bar configures an angle of 75 degrees to a plane perpendicular to the center plate thereby configuring the first flag staff and the second flag staff at an angle of inclination of 75 degrees to the plane perpendicular to the center plate and providing an aesthetic look to the flag display assembly upon engaging to the trailer hitch receiver.

10. The flag display assembly of claim 1, wherein the first flag staff and the second flag staff further comprise a first hole and a second hole disposed about the first top portion of the first flag staff and the second top portion of the second flag staff, respectively, the first hole and the second hole are capable of receiving a first flag wire and a second flag wire such that, the first flag wire and the second wire extends outwardly and laterally from the first top portion of the first flag staff and the second top portion of the second flag staff, respectively.

11. The flag display assembly of claim 10, wherein the first flag wire and the second flag wire enables in holding the first flag and the second flag in a full display condition in any wind load upon mounting the first flag on the first top portion of the first flag staff and second flag on the second top portion of the second flag staff, respectively.

12. The flag display assembly of claim 1, wherein the flag display assembly further comprises a plurality of nuts for firmly engaging the first flag staff and the first flag staff engaging member about the first end portion of the cross bar, and for firmly engaging the second flag staff and the second flag staff engaging member about the second end portion of the cross bar.
